(19) United States
(12) Patent Application Publication
(10) Pub. No.: US 2011/0042164 A1
(43) Pub. Date: Feb. 24, 2011

(54) APPARATUSES AND METHODS FOR DETERMINING AND CONTROLLING VEHICLE STABILITY

(75) Inventors: Brian M. Clark, Seattle, WA (US); Rainer Leuschke, Seattle, WA (US)

Correspondence Address: BROOKS KUSHMAN P.C., 1000 TOWN CENTER, TWENTY-SECOND FLOOR, SOUTHFIELD, MI, 48075, US

(73) Assignee: GENIE INDUSTRIES, INC., Redmond, WA (US)

(21) Appl. No.: 12/542,956

(22) Filed: Aug. 18, 2009

(51) Int. Cl. E04G 1/24; E04G 1/22; G01M 1/00

(52) U.S. Cl. 182/2.2; 182/63.1; 182/19; 73/65.01

(57) ABSTRACT

A vehicle for lifting a load with respect to a support surface includes a load carrying member configured to carry the load, a frame, and a support assembly coupling the load carrying member and the frame. The support assembly is configured to move the load carrying member between stowed and deployed positions with respect to the flame. The vehicle further includes a plurality of motion devices that support the frame relative to the support surface, and the motion devices are configured to move the frame along the support surface. In addition, the vehicle includes a control system associated with the motion devices and configured to determine contact forces between the motion devices and the support surface. The control system is further configured to determine stability of the vehicle based on the contact forces.

### BACKGROUND OF THE INVENTION

1. Field of the Invention

The following disclosure relates generally to vehicles for lifting a load with respect to a support surface. In particular, the following disclosure relates to vehicles that have support assemblies for moving a load carrying member between stowed and deployed positions with respect to a chassis.

2. Background Art

Vehicles such as a conventional mobile aerial work platform may be configured to wain the operator or prevent operation when a corresponding lift structure is elevated relative to a chassis, and the chassis is tilted greater than approximately five degrees. An alarm system that measures chassis tilt may prevent or restrict vehicle operation in many circumstances. For example, such a tilt alarm can be tripped when driving the vehicle in a raised or partially raised configuration over uneven support surfaces or on a support surface that slopes to one side causing the vehicle to potentially tilt beyond a selected operational envelope.

Some conventional four wheeled vehicles include fixed axles that do not permit wheels of the vehicle to move relative to the frame of the vehicle. On uneven terrain, it is therefore common for only three tires to be in contact with the ground at any given time. Additionally, it is common for the vehicle to “rock over” from one set of three wheels to another set of three wheels across an axis defined by diagonal wheels. Other conventional vehicles include an axle oscillation system or other axle adjustment systems to maintain contact between the tires and ground for stability and/or traction purposes. A vehicle of this type therefore may remain with its frame substantially parallel to the terrain directly beneath the vehicle.

Other conventional vehicles may incorporate auxiliary leveling jacks that lift the wheels off the ground and make the frame level with respect to gravity to enhance stability while elevated.

Another vehicle has incorporated active leveling of its chassis with respect to gravity by changing the vertical position of two of the wheels while the axle on the other end of the vehicle is permitted to oscillate, in effect creating a three point stance.

### SUMMARY

According to an exemplary embodiment of the present disclosure, a vehicle for lifting a load with respect to a support surface includes a load carrying member configured to carry the load, a frame, and a support assembly coupling the load carrying member and the frame. The support assembly is configured to move the load carrying member between stowed and deployed positions with respect to the flame. The vehicle further includes a plurality of motion devices that support the frame relative to the support surface, and the motion devices are configured to move the frame along the support surface. In addition, the vehicle includes a control system associated with the motion devices and configured to determine contact forces between the motion devices and the support surface. The control system is further configured to determine stability of the vehicle based on the contact forces.

A method is also provided for determining stability of a vehicle that is configured to lift a load with respect to a support surface, wherein the vehicle includes a load carrying member configured to carry the load, a frame, a support assembly that couples the load carrying member and the frame and that is configured to move the load carrying member between stowed and deployed positions with respect to the frame, and a plurality of motion devices that support the frame relative to the support surface and that are configured to move the frame with respect to the support surface in at least a forward direction. The method includes determining contact forces between the motion devices and the support surface as the motion devices move the frame with respect to the support surface, and determining stability of the vehicle based on the contact forces.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a partially schematic top plan view of an embodiment of a vehicle including a control system in accordance with the present disclosure;

FIG. 2 is a partially schematic side view of the vehicle shown in FIG. 1;

FIG. 3 is a schematic view of an embodiment of a control system in accordance with the present disclosure;

FIG. 4 is a schematic view of another embodiment of a control system in accordance with the present disclosure;

FIG. 5 is a side view of another embodiment of a vehicle in accordance with the present disclosure; and

FIG. 6 a side view of still another embodiment of a vehicle in accordance with the present disclosure.

### DETAILED DESCRIPTION

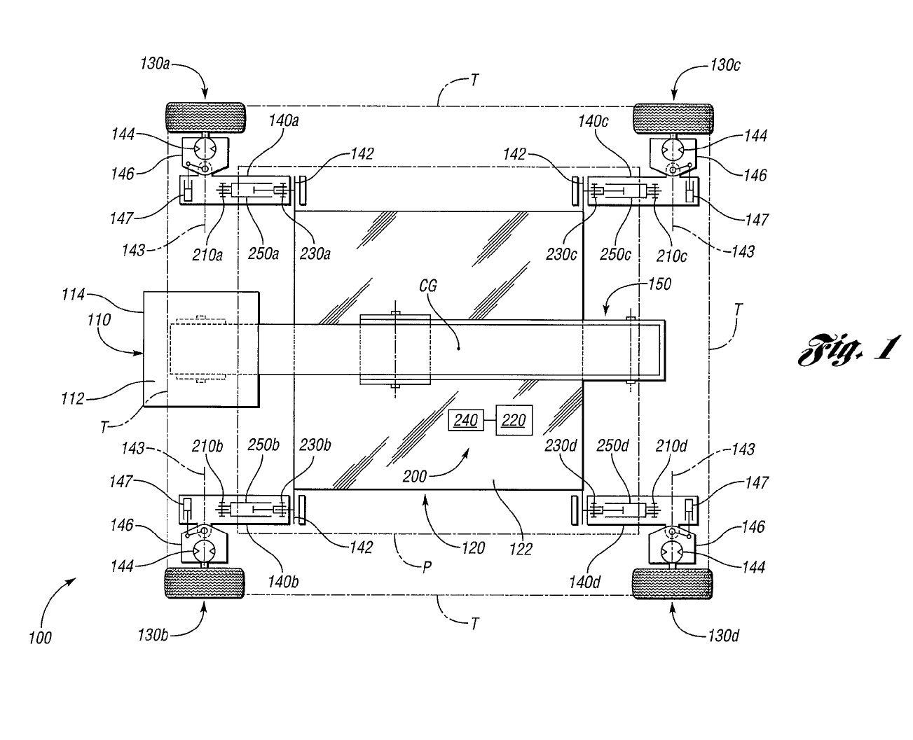

The present disclosure describes vehicles for lifting a load with respect to a support surface. Several specific embodiments are set forth in the following description and in FIGS. 1-6 to provide a thorough understanding of certain embodiments according to the present disclosure. As those of ordinary skill in the art will understand, various features of the embodiments illustrated and described with reference to any one of the Figures may be combined with features illustrated in one or more other Figures to produce embodiments that are not explicitly illustrated or described. In addition, other embodiments may be practiced without several of the specific features explained in the following description.

FIG. 1 is a partially schematic top plan view of an embodiment of a vehicle 100 including a control system in accordance with the present disclosure. FIG. 2 is a partially schematic side view of the vehicle 100 shown in FIG. 1. The vehicle 100 can be a utility vehicle, such as an aerial work platform, a mobile elevated work platform, a portable material lift, or a rough terrain telescopic load handler, or any other vehicle suitable for lifting a load L with respect to a support surface S. The load L can be, for example, one or more persons, tools, cargo, or any suitable material that may require being lifted. The support surface S can be paved or unpaved ground, a road, an apron such as a sidewalk or parking lot, an interior or exterior floor of a structure, or any other suitable surface upon which the vehicle 100 can be driven.

In FIG. 1, the vehicle 100 includes a load carrying member such as a platform 110, a chassis 120, and a support assembly 150 that couples the platform 110 and the chassis 120. The platform 110 shown in FIG. 1 includes a deck 112 with a railing 114 mounted on the deck 112. Such a platform 110 is particularly suited to carrying one or more persons and any tools or supplies that they may need. According to certain other embodiments of the present disclosure, the platform 110 can be any other structure that is suitably configured to carry the load L.

The chassis 120 generally includes a frame 122 and multiple motion devices, such as wheels 130, associated with the frame 122. In one embodiment, the vehicle 110 may be provided with at least three wheels 130 or other motion devices. In the embodiment shown in FIG. 1, the vehicle 110 includes four wheels 130, although the vehicle can have greater or fewer wheels or other motion devices. The wheels 130 (individual wheels 130a-d are shown in FIG. 1) support the frame 122 with respect to the support surface S and are configured to move the frame 122 with respect to the support surface S.

Although the illustrated embodiment includes wheels 130, other embodiments can include any other suitable motion devices, such as continuous tracks that each include a flexible or rigid belt and sprockets, for traversing the support surface S. Furthermore, any number of the motion devices may be driven by a drive system, as explained below for example, or any number of the motion devices may be non-driven. The motion devices may also be referred to as traction devices.

The chassis 120 may further include multiple movable supports, such as links 140 (individual links 140a-d are shown in FIG. 1), that each pivotally couple a corresponding wheel 130 to the frame 122. For example, each link 140 may be connected directly or indirectly to an axle associated with a corresponding wheel 130, and to the frame 122 by a pivot pin. The individual links 140 are each configured to pivot with respect to the frame 122 and the corresponding wheel 130 about an individual inboard axis 142 and an individual outboard axis 143, respectively. For the sake of drawing clarity, only single examples of the inboard axes 142 and outboard axes 143 are indicated in FIGS. 1 and 2. It is to be understood, however, that each individual link 140 may have a corresponding individual inboard axis 142 and a corresponding individual outboard axis 143. Furthermore, the inboard and outboard axes 142 and 143 may extend approximately horizontally. With such a configuration, each link 140 and corresponding wheel 130 may move in an arcuate path that lies in a generally vertically oriented plane (not shown). Certain other embodiments according to the present disclosure can include pivot axes that are oriented in any suitable direction, such as a direction other than generally horizontal. Furthermore, while the pivot axes 142 and 143 are oriented generally perpendicular to a longitudinal centerline of the vehicle 100, other embodiments may include pivot axes that extend-generally parallel to the vehicle centerline, or at any suitable angle relative to the centerline.

In other embodiments, the wheels 130 or other motion devices may be moveably coupled to the frame 122 in any suitable manner. For example, each wheel 130 or other motion device may be coupled to the frame 122 with a telescoping support or a four bar linkage.

The vehicle 100 may also include a drive system for driving one or more wheels 130, and a steering system that is configured to adjust the angular position of one or more of the wheels 130. In the embodiment shown in FIG. 1, for example, all wheels 130 are coupled to a drive system and a steering system. As a more detailed example, the vehicle 100 may include multiple drive motors 144, such as electric drive motors or hydraulic drive motors, that are each connected to an axle or spindle associated with a respective wheel 130 for providing drive power to the wheel 130. Reduction gearing (not shown) may also be provided between each drive motor 144 and associated wheel 130, such as at the wheel hub.

In addition, the vehicle 100 shown in FIG. 1 includes a steering system having multiple steer members, such as steer yokes 146, that are each pivotally connected to a corresponding link 140, such as with a pivot pin, and that support a corresponding drive motor 144 and spindle. The steering system may further include multiple steer actuators 147, such as hydraulic cylinders, that are each connected between a corresponding link 140 and steer yoke 146 for rotating or pivoting the steer yoke 146 with respect to the link 140 about a generally vertical axis.

In other embodiments, only select motion devices may be coupled to a drive system and/or steering system. In one embodiment, for example, the front wheels 130 or other motion devices may be coupled to a steeling system, and the rear wheels 130c,d or other motion devices may be coupled to a drive system.

The support assembly 150 is connected between the platform 110 and the frame 122, and is configured to move the platform 110 between a stowed position and a deployed position with respect to the frame 122. In the embodiment shown in FIG. 2, the support assembly includes a boom 152 with articulated boom segments 152a and 152b. The boom segment 152a is pivotally coupled at its ends by pins 154a and 154b with respect to the frame 122 and the boom segment 152b, respectively. The boom segment 152b is pivotally coupled at its ends by pins 154b and 154c with respect to the boom segment 152a and the platform 110, respectively. One or more actuators 155, such as hydraulic actuators, may be used to move the boom segments 152a and 152b with respect to the platform 110 and the frame 122 to move the platform 110 between the stowed and deployed positions. One or more actuators 156 may also be used to move the platform 110 with respect to the boom segment 152b.

In the embodiment shown in FIG. 1, the vehicle 100 also includes a control system 200 that may be used to determine stability of the vehicle 100. In addition, the control system 200 may be used to control stability of the vehicle 100, as well as other aspects of the vehicle 100, as explained below in detail.

Referring to FIGS. 1-3, the control system 200 may include a plurality of detection members, such as sensors 210 (individual sensors 210a-d are shown in FIG. 1), that are in communication with a controller 220, which may include one or more control units or modules for example. Each sensor 210 may be configured to detect (e.g., monitor and/or measure) individual contact forces, or a parameter related to contact force, between a corresponding wheel 130 and the support surface S, and the controller 220 may be configured to receive and process information from the sensors 210. Each contact force may include a friction component that lies within the plane of contact, and a normal force that is perpendicular to the plane of contact. Furthermore, each wheel 130 may exert a contact force on the support surface S, and the support surface S may exert an equal and opposite contact force on the wheel.

Each control unit of the controller 220 may include, for example, a central processing unit (CPU) including a microprocessor, and a memory management unit (MMU) in communication with the CPU. The MMU may control movement of data among various computer readable storage media and communicate data to and from the CPU. In one embodiment, the computer readable storage media include stored data or code representing instructions executable by controller 220 to determine vehicle stability, as well as to control vehicle stability, based on data from the sensors 210. The sensors 210 can include, for example, pressure transducers, load cells, strain gauges, and/or other suitable devices for measuring forces, strains, accelerations, or other manifestations that directly or indirectly correspond to the contact force between individual wheels 130 and the support surface S.

The sensors 210 and the controller 220 may be configured to detect changes in the individual contact forces due to, for example, the vehicle 100 being driven over uneven or sloped ground, or if a wheel 130 rolls off a curb or over some other depression or bump in the support surface S. The sensors 210 and controller 220 can also be configured to detect a change of contact force of one or more wheels 130 due to, as examples, the support assembly 150 moving the platform 110 laterally or vertically with respect to the chassis 120, a shift in the load L, or any other force or configuration that changes the angular attitude of the vehicle 100.

The control system 200 can optionally include additional sensors that are in communication with the controller 220 for determining attitude or other operational configuration of the vehicle 100. For example, position sensors 230 (individual position sensors 230a-d are shown in FIG. 1) can be configured to measure or otherwise detect the angular orientation of a corresponding individual link 140 with respect to the flame 122. One or more inertial sensors and/or tilt sensors 240, such as accelerometers and/or angular rate sensors, can be configured to measure or otherwise detect an angular orientation of the frame 122 relative to horizontal, or attitude of the frame 122 relative to gravity. In addition, one or more sensors 242, such as inertial sensors and/or tilt sensors, can be configured to measure or otherwise detect angular orientation of each boom segment 152a and 152b relative to horizontal, or attitude of each boom segment relative to gravity. Other sensors, such as inertial sensors and/or tilt sensors, can be configured to measure other aspects of the vehicle, such as angular orientation of the platform 110 relative to horizontal, or attitude of the platform 110 relative to gravity.

The control system 200 may further include one or more actuators 250 (individual actuators 250a-d are shown in FIG. 1) that are in communication with the controller 220 and that are configured to move one or more of the wheels 130 with respect to the frame 122. For example, the embodiment shown in FIGS. 1 and 2 includes multiple actuators 250 that are each pivotally coupled between the frame 122 and a corresponding link 140 for a corresponding wheel 130, and each actuator 250 is configured to independently angularly orient a corresponding link 140 with respect to the frame 122. In addition, the control system 200 may include one or more sensors, such as sensors 230, that are each associated with a respective actuator 250 for measuring or otherwise detecting the position of the actuator 250 (e.g., how far the actuator 250 is extended and/or angular orientation of the actuator 250).

Certain other embodiments according to the present disclosure can include individual actuators that are connected between a vehicle frame and a corresponding axle or other portion of a wheel assembly. For example, a vehicle having a front axle that supports two front wheels and a rear axle that supports two rear wheels, may include a control system having one actuator connected to the front axle and/or one actuator connected to the rear axle.

In addition, the control system 200 may be used to control the drive system and steering system of the vehicle 100. For example, the drive motors 144 and steer actuators 147 may be in communication with the controller 220, and the controller 220 may be configured to control operation of those components.

The control system 200 may also be used to control operation of the support assembly 150. For example, the controller 220 may be in communication with the actuators 155 and 156 and configured to control operation of the actuators 155 and 156 to move the platform 110 between the stowed and deployed positions. Furthermore, the controller 220 may be configured to control operation of the actuators 155 and 156 to maintain orientation of the support assembly 150 with respect to gravity as inclination of the chassis 120 or frame 122 varies. For example, the controller 220 may extend or retract one or more of the actuators 155 in order to maintain the support assembly 150 in a particular angular orientation with respect to gravity as inclination of the chassis 120 or frame 122 varies.

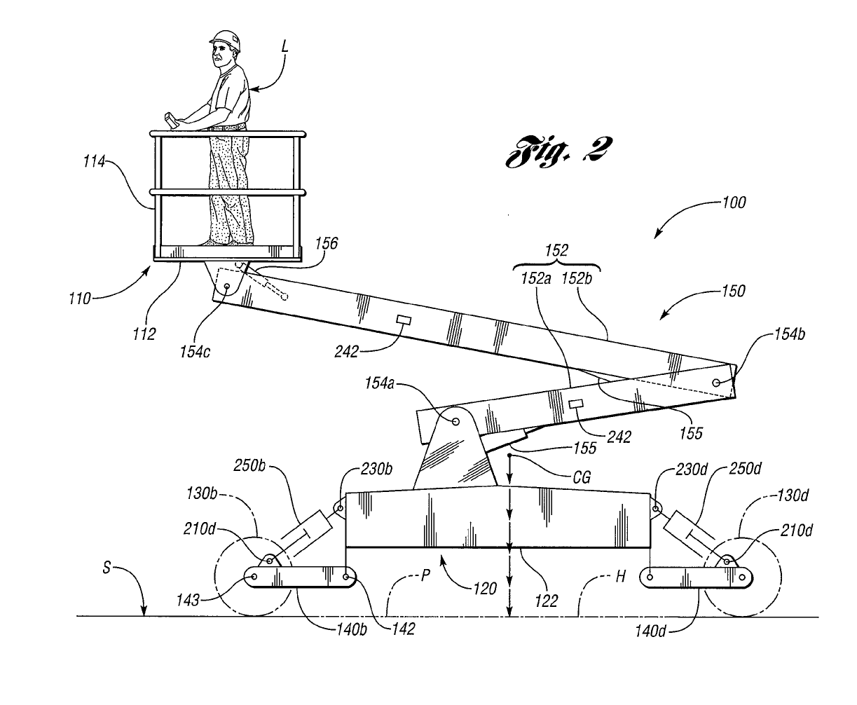

FIG. 3 shows a schematic view of an embodiment of the control system 200 in accordance with the present disclosure. In particular, the control system 200 includes controller 220, the individual contact force sensors 210, the individual position sensors 230, the tilt sensor 240, the sensors 242 and the individual actuators 250. Although wire connections are shown between the various components and the controller 220, the control system 200 may be configured such that the components communicate wirelessly.

In the embodiment shown in FIG. 3, the sensors 210 are associated with the actuators 250. More specifically, each actuator 250 in FIG. 3 is a hydraulic actuator that includes a hydraulic cylinder, and each sensor 210 includes one or more pressure transducers that measure the pressure in the corresponding cylinder of a corresponding actuator 250. For example, each sensor 210 may include one or more pressure transducers coupled to lines supplying hydraulic fluid to a respective cylinder. With such a configuration, the controller 220 may control operation of the actuators 250 by opening and/or closing hydraulic control valves associated with the hydraulic fluid lines.

FIG. 4 shows a schematic view of another embodiment of a control system 200′ in accordance with the present disclosure. In particular, the control system 200′ has multiple actuators 250 that include electric or electromagnetic actuators in lieu of the hydraulic cylinders according to the embodiment shown in FIG. 3. As shown in FIG. 4, an example of a suitable electromagnetic actuator can include an electric motor that drives a screw and nut linkage to angularly orient a corresponding link 140 with respect to the frame 122. Individual sensors 210 for the control apparatus 200′ shown in FIG. 4 can each include one or more strain gauges that measure or otherwise detect the reaction force exerted by the frame 122 on an individual electromagnetic actuator, for example.

In addition, individual sensors 230 for the control apparatus 200′ shown in FIG. 4 may measure the angular orientation of an individual electromagnetic actuator. According to other embodiments, individual position sensors 230 can measure any suitable quantity that directly or indirectly indicates the position of individual wheels 130.

According to other embodiments, the actuators 250 may be any suitable devices for causing movement of the wheels 130 or other motion devices, and the sensors 210 may be any suitable devices that detect (e.g., monitor and/or measure) any suitable parameter that directly or indirectly indicates or is related to the contact force of the individual wheels 130 or other motion devices, e.g., such as by measuring the force exerted by an individual electromagnetic actuator on a corresponding link 140. As another example, sensors 210 may be mounted on or otherwise incorporated into load pins that connect the links 140 to the frame 122, and each sensor 210 may be configured to measure or otherwise detect the force exerted by a corresponding link 140 on the frame 122.

According to certain embodiments of the present disclosure, the control system 200 may be configured to determine stability of the vehicle 100 based on contact forces, as well as other sensed parameters of the vehicle 100, as explained below in detail. In addition, the control system 200 may be configured to control or adjust stability of the vehicle 100.

In one embodiment, the controller 220 may be configured to determine contact forces between the wheels 130 and the support surface S based on information from various sensors, such as the sensors 210, 230, 240, 242. For example, if the actuators 250 include hydraulic cylinders, the contact forces between the wheels 130 and the support surface S may be determined based on the cylinder pressures, the known geometry of the cylinders, the actuator displacements and the chassis tilt angle.

The controller 220 may then determine a location of a vehicle center of gravity based on the detected contact forces, and determine stability of the vehicle 100 based on the location of the center of gravity. For example, the controller 220 may evaluate the lateral position of the center of gravity relative to a tip line T of the vehicle 100, which is a line about which the vehicle 100 may tip. As a more detailed example, the controller 220 may determine a projected location of the vehicle center of gravity that is projected vertically onto the support surface S, and evaluate that projected location relative to the tip line T, which may also be located at the support surface. For instance, the controller 220 may determine whether or not the projected location of the center of gravity is located at or greater than a sufficient minimum lateral distance from the tip line T.

As another example, the controller 220 may evaluate the lateral position of the center of gravity relative to an operating envelope of the vehicle 100. As it is used in the present disclosure, the phrase “operating envelope” includes the lateral positions of the center of gravity wherein there exists a sufficient positive contact force between the support surface S and all of the wheels 130 to insure that the vehicle does not encounter a configuration susceptible to excessive tipping forces or lateral instability during operation.

Referring again to FIGS. 1 and 2, the lateral position of the center of gravity may be the vertical projection of the center of gravity onto the support surface S or a hypothetical plane H that is generally coplanar with the support surface S or generally parallel with the support surface S, for example. In other embodiments, the hypothetical plane H may be generally parallel to the frame 122 or generally horizontal. In FIG. 1, the operating envelope is represented on the hypothetical plane H by a perimeter P, which may be bounded on each side by a tire tip line or a vertical projection of a tire tip line, for example. According to certain embodiments of the present disclosure, if the vertical projection of the center of gravity CG intersects the hypothetical plane H inside the perimeter P, then the stability of the vehicle 100 is sufficient to continue operating the vehicle 100. If, on the other hand, the vertical projection of the center of gravity CG intersects the hypothetical plane H on or outside the perimeter P, then the stability of the vehicle 100 may be approaching an undesirable configuration, and operation of the vehicle 100 may be fully or partially ceased or the operational configuration may be adjusted until sufficient stability is established.

The selection of the perimeter P can be determined empirically or the vehicle 100 can be modeled and tested, e.g., by computer analysis. Moreover, the selection of the perimeter P may include a factor of safety so as to avoid inadvertently approaching an undesirable condition of the vehicle 100. For example, after determining a boundary at the limit of vehicle stability, the perimeter P can be selected such that it is inside of that boundary. Certain other embodiments according to the present disclosure can include varying preferred operational factors and therefore the possibility of more than one perimeter P (not shown).

As noted above, determining the location of the center of gravity may include calculating the center of gravity CG based on sensing the individual contact forces between the wheels 130 and the support surface S. According to other embodiments of the present disclosure, calculation of the center of gravity CG may additionally be based on sensing a tilt angle of the frame 122, sensing positions of the individual wheels 130 or links 140 with respect to the frame 122, sensing tilt angle of the platform 110, sensing tilt angle of the support assembly 150, and/or sensing any other suitable aspects or parameters of the vehicle 100.

Alternatively or supplementally, the controller 220 may be configured to determine a vehicle weight based on the detected contact forces, and then compare that vehicle weight to a threshold value to determine if the vehicle 100 is approaching an unstable operating condition or a structural limit. As a more specific example, the determined vehicle weight may be based on the difference between a loaded vehicle weight and a base vehicle weight, such that the determined vehicle weight is indicative of weight of the load carried by the platform 110, and the controller 220 may be configured to compare that vehicle weight to a predetermined maximum value.

As another example, the controller 220 may compare the detected contact forces or related values for one or more wheels 130 to a predetermined minimum value, or a fluctuating minimum value that is based on a minimum percentage of the contact forces or related values for one or more other wheels 130. As a more specific example, the controller 220 may compare the detected contact force or related value for each wheel 130 to a predetermined minimum value or a predetermined minimum percentage of the total vehicle load or weight. As another more specific example, the controller 220 may compare the detected contact forces or related values for uphill wheels 130 to a minimum percentage, such as ten percent, of the total contact forces or related values for the downhill wheels 130 to determine stability of the vehicle 100.

As yet another example, the controller 220 may determine a moment about a vehicle tip line based on one or more of the contact forces in order to determine vehicle stability.

In addition to determining stability of the vehicle 100, the control system 200 may also be configured to control or adjust stability of the vehicle 100 such as by controlling operation of one or more actuators 250. For example, if the controller 220 determines that stability of the vehicle 100 is approaching an undesirable condition (e.g., contact forces for one or more wheels 130 are approaching or have dropped below a threshold value), the controller 220 may extend or retract one or more actuators 250 in order to maintain desired contact forces, such as predetermined minimum contact forces, between each of the wheels 130 and the support surface S. As another example, if the controller 220 determines that vehicle 100 is approaching an unstable condition based on the location of the vehicle center of gravity, the controller 220 may adjust one or more of the actuators 250 to adjust or control the lateral position of the vehicle's center of gravity as needed to insure that the operational configuration remains within the operating envelope.

According to other embodiments of the present disclosure, the controller 220 may move individual links 140 and wheels 130 with respect to the frame 122 to compensate for vehicle load changes and/or to maintain the frame 122 in a substantially level condition. Still further, the controller 220 may be configured to adjust one or more actuators 155 to maintain orientation of the support assembly 150 with respect to gravity as inclination of the chassis 120 varies.

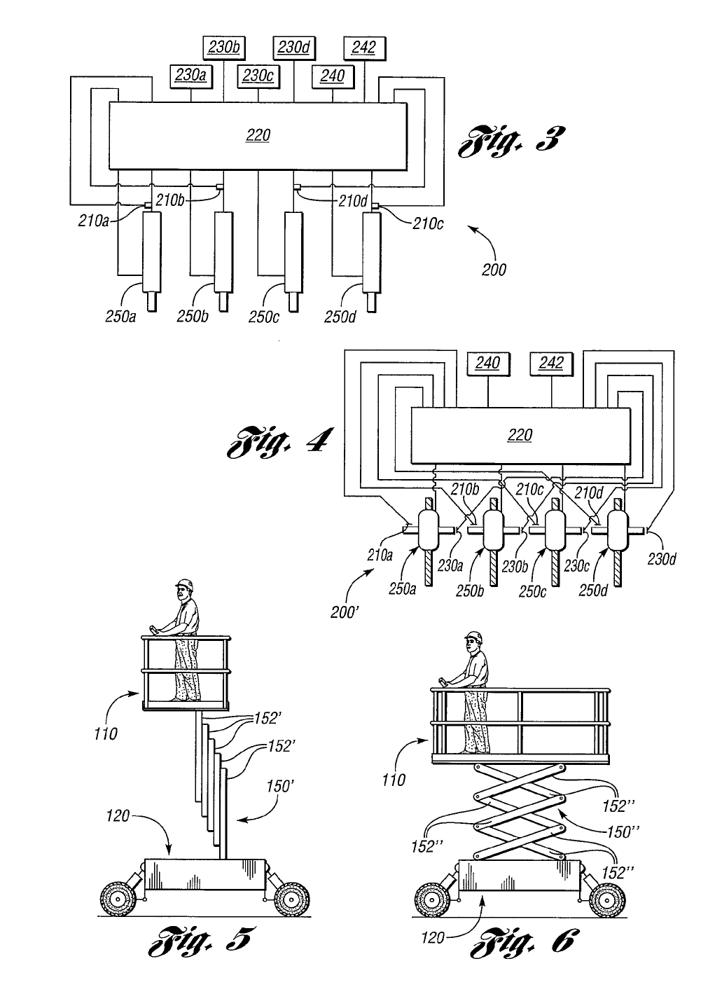

FIGS. 5 and 6 are side views of other embodiments of vehicles in accordance with the present disclosure. In FIG. 5, a support assembly 150′ includes an extensible mast in lieu of the articulated boom 150 of FIGS. 1 and 2. Specifically, the support assembly 150′ includes a plurality of segments 152′ that are extensible with respect to one another to deploy the platform 110 (generally shown in FIG. 5), and are retractable with respect to one another to stow the platform 110 (not shown). In FIG. 6, the support assembly 150″ includes a scissor apparatus in lieu of the articulated boom 150 of FIGS. 1 and 2. Specifically, the support assembly 150″ includes a plurality of segments 152″ that are pinned together as a linkage that is spread to deploy the platform 110 (generally shown in FIG. 6), and is folded to stow the platform 110 (not shown). Still other embodiments according to the present disclosure may additionally or alternatively include telescopic boom members or other linkages that facilitate lifting a load.

Certain embodiments according to the present disclosure can provide a number of advantages. For example, stability control can be achieved by setting a minimum distance between the operating envelope or perimeter P and the projected vehicle center of gravity. Tipping motion may be prevented by moving the vehicle into a configuration where the center of gravity CG can approach but remains inside the perimeter P. The vehicle operating envelope can be expanded or maximized by determining actual stability of the vehicle, as opposed to inferring stability based on the position of the vehicle. Normal force control for the purpose of aiding traction can be achieved by extending or retracting actuators so that the motion devices each maintain a minimum normal force or contact force with the support surface S that is conducive to traction, or so that the normal force or contact force between each wheel and the support surface S is maintained within a desired range that is conducive to traction. Chassis leveling up to a maximum slope can be achieved because each motion device may be extended or retracted independently. Platform loading can be sensed if, for example, the variable weight of vehicle fuel is taken into consideration. Vehicle stability can be achieved regardless of which motion device encounters a terrain obstacle, and therefore regardless of the direction in which the vehicle is moving when it encounters the obstacle. Vehicle operation may be possible on grades, such as 10 degrees or more, that may trip a conventional 5 degree chassis tilt alarm, friction permitting. Additionally, chassis leveling may permit the use of a chassis tilt alarm with a smaller trip range or target, such as 3 degrees, which would allow a reduction in vehicle weight and/or counterweight.

From the foregoing, it will be appreciated that specific embodiments of the invention have been described herein for purposes of illustration, but that various modifications may be made without deviating from the spirit and scope of the invention. For example, in one embodiment, a control system can combine electric sensors and electric valves to control hydraulic actuators. Accordingly, the invention is not limited except as by the appended claims.

What is claimed is:

1. A vehicle for lifting a load with respect to a support surface, the vehicle comprising:
a load carrying member configured to carry the load;
a frame;
a support assembly coupling the load carrying member and the frame, the support assembly being configured to move the load carrying member between stowed and deployed positions with respect to the frame;
a plurality of motion devices that support the frame relative to the support surface, the motion devices being configured to move the frame along the support surface; and
a control system associated with the motion devices and configured to determine contact forces between the motion devices and the support surface, wherein the control system is further configured to determine stability of the vehicle based on the contact forces.

2. The vehicle of claim 1 wherein the control system includes a plurality of detection members associated with the motion devices and configured to detect a parameter that is related to the contact forces between the motion devices and the support surface, and a controller in communication with the detection members.

3. The vehicle of claim 1 wherein the plurality of motion devices includes at least four motion devices, and wherein the vehicle further includes at least one actuator associated with at least one of the motion devices for moving the at least one motion device to compensate for variations in the support surface to maintain minimum contact forces on all motion devices.

4. The vehicle of claim 3 wherein the control system is configured to maintain the frame in a substantially level condition as inclination of the support surface varies.

5. The vehicle of claim 1 wherein the control system is configured to determine a vehicle weight based on the contact forces.

6. The vehicle of claim 1 wherein the support assembly is tiltable with respect to the frame, and wherein the control system is configured to maintain orientation of the support assembly with respect to gravity as inclination of the frame varies.

7. The vehicle of claim 6 wherein the control system is configured to determine a vehicle weight based on the contact forces, and wherein the vehicle weight is indicative of weight of the load carried by the load carrying member.

8. The vehicle of claim 1 wherein the control system is configured to determine a location of a vehicle center of gravity based on the contact forces.

9. The vehicle of claim 8 wherein the location of the vehicle center of gravity is a projected location that is projected onto the support surface, and wherein the control system is further configured to evaluate the projected location relative to a tip line or operating envelope of the vehicle.

10. The vehicle of claim 1 wherein the control system is configured to determine a moment about a vehicle tip line based on at least one of the contact forces.

11. The vehicle of claim 1 wherein the control system is configured to compare at least one of the contact forces to a threshold value.

12. The vehicle of claim 11 wherein the threshold value is based on a minimum contact force.

13. The vehicle of claim 11 wherein the threshold value is based on a percentage of at least one other contact force.

14. The vehicle of claim 1 wherein the control system includes a plurality of actuators associated with the motion devices, each actuator being configured to move a corresponding motion device with respect to the frame, and wherein the control system is configured to actuate at least one of the actuators to maintain positive contact force between each of the motion devices and the support surface.

15. A method for determining stability of a vehicle that is configured to lift a load with respect to a support surface, the vehicle including a load carrying member configured to carry the load, a frame, a support assembly that couples the load carrying member and the frame and that is configured to move the load carrying member between stowed and deployed positions with respect to the frame, and a plurality of motion devices that support the frame relative to the support surface and that are configured to move the frame with respect to the support surface in at least a forward direction, the method comprising:
determining contact forces between the motion devices and the support surface as the motion devices move the frame with respect to the support surface; and
determining stability of the vehicle based on the contact forces.

16. The method of claim 15 further comprising moving at least one of the motion devices with respect to the frame in a generally upward or generally downward direction to maintain minimum contact forces on all motion devices.

17. The method of claim 15 wherein determining stability of the vehicle includes determining a location of a vehicle center of gravity based on the contact forces.

18. The method of claim 15 wherein determining stability of the vehicle includes determining a projected location of a center of gravity of the vehicle that is projected onto the support surface, and wherein the method further includes evaluating the projected location relative to a tip line or operating envelope of the vehicle.

19. The method of claim 15 wherein determining stability of the vehicle includes determining a moment about a vehicle tip line based on at least one of the contact forces.

20. The method of claim 15 wherein determining stability of the vehicle includes comparing at least one of the detected contact forces to a threshold value.
